(19) United States
(12) Patent Application Publication
(10) Pub. No.: US 2026/0103184 A1
(43) Pub. Date: Apr. 16, 2026

(54) METHOD AND DEVICE FOR ACQUIRING LEARNING DATA FOR A DRIVING ASSISTANCE MODEL

(71) Applicants: HYUNDAI MOTOR COMPANY, Seoul (KR); KIA CORPORATION, Seoul (KR)

(72) Inventors: Jun Ho Song, Hwaseong-si (KR); Hyun Kyu Lim, Hwaseong-si (KR)

(73) Assignees: HYUNDAI MOTOR COMPANY, Seoul (KR); KIA CORPORATION, Seoul (KR)

(21) Appl. No.: 19/350,821

(22) Filed: Oct. 6, 2025

(30) Foreign Application Priority Data
Oct. 10, 2024 (KR) 10-2024-0137683

(51) Int. Cl. B60W 30/06; B60W 50/04; G06V 10/774; G06V 20/56; G07C 5/02

(52) U.S. Cl. CPC B60W 30/06; B60W 50/04; G06V 10/774; G06V 20/56; G07C 5/02; B60W 2420/403; B60W 2510/1005; B60W 2520/04; B60W 2556/45

(57) ABSTRACT

A method and device for acquiring leaning data for driving assistance model includes acquiring vehicle data including at least one of a state of a component of a vehicle occurring in driving or a control instruction for the component and image data for detecting a surrounding environment by a sensor of the vehicle. The method also includes generating behavior information of the vehicle based on motion of the vehicle estimated from the vehicle data. The method additionally includes acquiring image data of the vehicle related to the behavior information matching a target behavior as learning data. The method also includes learning a driving assistance model using the learning data and controlling the vehicle using the driving assistance model.

### CROSS-REFERENCE TO RELATED APPLICATION

This application claims priority to and the benefit of Korean Patent Application No. 10-2024-0137683 filed on Oct. 10, 2024, the entire contents of which are hereby incorporated herein by reference.

### BACKGROUND

### Technical Field

The present disclosure relates to a method and a device for acquiring learning data for a driving assistance model, and more particularly, to a method and a device for acquiring learning data that achieve an improvement in acquisition efficiency and a reduction in acquisition time for high-quality learning data.

### Discussion of Related Art

In recent years, vehicles have been commercially available with an autonomous driving function for driving convenience. The autonomous driving function is being developed to realize fully autonomous driving in which the vehicle completely controls driving control without driver intervention in any situation. Prior to transition to fully autonomous driving, some functions of fully autonomous driving have been installed and utilized in commercially available vehicles.

An autonomous driving-based vehicle may recognize the surrounding environment acquired by a sensor, acquire various data from inside and outside the vehicle, identify a situation around the vehicle based on the recognized surrounding environment and the data, establish an autonomous driving strategy or control plan corresponding to the identified situation, and control an actuator of the vehicle for driving according to the strategy.

A driving assistance model for autonomous driving may be mounted on a vehicle and/or a server controlling the vehicle. The driving assistance model have been recently built into an artificial intelligence network. Existing models are mainly focused on deep learning-based route prediction for vehicles driving on a road, so that learning data related to a road condition may be sufficiently accumulated. However, due to lack of learning data related to various driving situations, e.g., parking situations, existing driving assistance models have low performance in predicting the environment around the vehicle in parking situations. In order to usefully generate or re-learn a model related to surrounding environment prediction, learning data related to a specific driving situation is collected and tagged learning data is provided for learning of the model.

A conventional method of acquiring learning data specifically relies on manual labeling in which an operator selects video data matching a specific driving situation while checking video data of a vehicle, and labels the situation on the selected video data. The manual labeling does not ensure label consistency due to varying proficiency from one operator to another, errors due to excessive work, etc. In addition, a problem arises that the manual labeling is significantly poor in terms of efficiency of acquisition of learning data and working time.

### SUMMARY

Embodiments of the present disclosure provide a method and a device for acquiring learning data that achieve an improvement in acquisition efficiency and a reduction in acquisition time for high-quality learning data.

The technical problems to be solved in the present disclosure are not limited to the above-mentioned technical problems. Other technical problems that are not mentioned herein should be more clearly understood by those having ordinary skill in the art in the art to which the present disclosure pertains from the following description.

According to an embodiment of the present disclosure, a method for acquiring learning data for a driving assistance model is provided. The method includes acquiring vehicle data including at least one of a state of a component of a vehicle occurring in driving or a control instruction for the component and image data for detecting a surrounding environment by a sensor of the vehicle and generating behavior information of the vehicle based on motion of the vehicle estimated from the vehicle data. The method also includes acquiring image data of the vehicle related to the behavior information matching a target behavior as learning data. The method additionally incudes learning a driving assistance model using the learning data. The method further includes controlling the vehicle using the driving assistance model.

According to an embodiment of the present disclosure, the vehicle data may include at least one of longitudinal data of the vehicle, lateral data of the vehicle, or gear shift data indicating a driving direction and a stop of the vehicle.

According to an embodiment of the present disclosure, the vehicle data may be acquired from at least one of i) the gear shift data and at least one of the longitudinal data and the lateral data determined by a search using shift time information of the gear shift data or ii) vehicle data determined by a searching using image time information of the image data.

According to an embodiment of the present disclosure, the behavior information may include the vehicle data and behavior attribute data generated by analyzing the vehicle data and a unit motion characteristic represented by templated motion of the vehicle according to a trajectory caused by driving of the vehicle. The behavior attribute data may be arranged in a plurality in time series and is managed in association with the vehicle data used for generation of the behavior attribute data.

According to an embodiment of the present disclosure, generating the behavior information may include: generating a trajectory of the vehicle based on the vehicle data; dividing the trajectory into specified time periods to generate a separation trajectory; respectively matching a plurality of unit template routes defined by unit motion characteristics classified according to individual motion characteristics of the separation trajectory into trajectory target classes for each separation trajectory; connecting the matched unit template routes to generate template routes with continuous unit motion characteristics; and generating the behavior information based on the template route and the vehicle data.

According to an embodiment of the present disclosure, the method may further comprise defining the trajectory target classes based on the individual motion characteristics of the separation trajectory, before matching the plurality of unit template routes, to provide a unit template route for each of the defined trajectory target classes.

According to an embodiment of the present disclosure, matching the plurality of unit template routes may include matching the plurality of unit template routes using non-linear matching based on dynamic time warping between a unit template route and a separation trajectory.

According to an embodiment of the present disclosure, the method may further comprise normalizing the separation trajectory and the unit template route before the matching.

According to an embodiment of the present disclosure, the vehicle data may include longitudinal data of the vehicle, lateral data of the vehicle and gear shift data indicating a direction of driving and a stop of the vehicle. Generating behavior information may include: searching, among the plurality of unit template routes constituting the template routes, a unit template route corresponding to a shift time at which the gear shift data is generated; generating the behavior information, so as to have behavior attribute data that is determined to be parking, based on determining that the unit template route corresponding to the gear shift data includes a stop and the gear shift data includes a stop instruction; generating the behavior information so as to have behavior attribute data that is determined to be parking or exiting, based on determining i) that the gear shift data is an indication of a driving direction and ii) that the lateral data and the longitudinal data of a specific wheel satisfy threshold conditions; generating the behavior information so as to have behavior attribute data based on the unit motion characteristic, based on determining i) that the gear shift data is an indication of the driving direction and ii) that at least one of the lateral direction data or the longitudinal direction data does not satisfy a threshold condition; and generating the behavior information so as to have behavior attribute data determined by parking space searching, based on determining that there is no gear shift data in the unit template route subsequent to the unit template route searched corresponding to the shift time.

According to an embodiment of the present disclosure, acquiring image data may include selecting, by the vehicle, image data related to the behavior information matching the target behavior, to acquire the image data as the learning data; and notifying, by the vehicle, image time information of the image data selected as the learning data to a server. The method may further comprise, before the learning the driving assistance model, transmitting, by the server, the image time information to the vehicle in response to satisfaction of a transmission condition in the vehicle; and transmitting, by the vehicle, learning data in which the behavior information is tagged to the image data associated with the image time information to the server.

According to an embodiment of the present disclosure, learning a driving assistance model may include: generating surrounding environment information of the driving assistance model by input of the learning data; determining learning data of the surrounding environment information corresponding to a target situation as final learning data; and training or updating the driving assistance model using the final learning data.

According to an embodiment of the present disclosure, driving may include an autonomous parking operation of the vehicle, and the driving assistance model may comprise an artificial intelligence network and includes a surrounding environment prediction model utilized in the autonomous parking operation.

According to another embodiment of the present disclosure, a device for acquiring learning data for a driving assistance model is provided. The device comprises a transceiver for transmitting and receiving data with an external device, a memory for storing at least one instruction, and a processor configured to execute the at least one instruction stored in the memory. The processor is configured to acquire vehicle data including at least one of a state of a component of a vehicle occurring in driving or a control instruction for the component and image data for detecting a surrounding environment by a sensor of the vehicle. The processor is also configured to generate behavior information of the vehicle based on motion of the vehicle estimated from the vehicle data. The processor is additionally configured to acquire image data of the vehicle related to the behavior information matching a target behavior as learning data of the driving assistance model. The processor is further configured to control the vehicle using the driving assistance model learned with the learning data.

The features briefly summarized above for this disclosure are only illustrative aspects of the detailed description of the disclosure below, and are not intended to limit the scope of the disclosure.

The technical problems solved by the present disclosure are not limited to the above technical problems. Other technical problems not described herein should be more clearly understood by a person having ordinary skill in the technical field, to which the present disclosure pertains, from the following description.

### BRIEF DESCRIPTION OF THE DRAWINGS

FIG. 1 is a diagram illustrating that a vehicle communicates with another device to transmit and receive data, according to an embodiment of the present disclosure.

FIG. 2 is a diagram illustrating modules constituting a vehicle, according to an embodiment of the present disclosure.

FIG. 3 is a diagram illustrating modules constituting a server, according to another embodiment of the present disclosure.

FIG. 4 is a flowchart of a method for acquiring learning data, according to another embodiment of the present disclosure.

FIG. 5 is a diagram illustrating acquisition of vehicle data, according to an embodiment of the present disclosure.

FIG. 6 is a flowchart of a process of generating behavior information, according to an embodiment of the present disclosure.

FIG. 7 is a diagram illustrating a trajectory of a vehicle generated by a vehicle dynamics model, according to an embodiment of the present disclosure.

FIG. 8 is a diagram illustrating a separation trajectory, according to an embodiment of the present disclosure.

FIG. 9 is a diagram illustrating a unit template route, according to an embodiment of the present disclosure.

FIG. 10 is a diagram illustrating a template route, according to an embodiment of the present disclosure.

### DETAILED DESCRIPTION

Hereinafter, embodiments of the present disclosure are described in detail with reference to the accompanying drawings to enable those having ordinary skill in the art to implement and practice the present disclosure. However, the present disclosure may be implemented in various different ways, and is not limited to the embodiments described therein.

In describing embodiments of the present disclosure, where it was determined that well-known functions or constructions would obscure the gist of the present disclosure, the detailed description thereof has been omitted. The same constituent elements in the drawings are denoted by the same reference numerals, and a repeated description of the same elements has been omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with one or more other elements intervening therebetween. When an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an embodiment could be termed a second element in another embodiment, and, similarly, a second element in an embodiment could be termed a first element in another embodiment, without departing from the scope of the present disclosure.

In the present disclosure, elements that are distinguished from each other are for clearly describing each feature, and do not necessarily mean that the elements are separated. For example, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

The advantages and features of the present disclosure and the way of attaining them should become more apparent with reference to embodiments described below in detail in conjunction with the accompanying drawings. Embodiments, however, may be embodied in many different forms and should not be constructed as being limited to example embodiments set forth herein. Rather, the example embodiments are provided to make this disclosure complete and to fully convey the scope of the present disclosure to those having ordinary skilled in the art.

In the present disclosure, each of phrases such as “A or B”, “at least one of A and B”, “at least one of A or B”, “A, B or C”, “at least one of A, B and C”, and “at least one of A, B, C or combination thereof” may include any one or all possible combinations of the items listed together in the corresponding one of the phrases.

In the present disclosure, expressions of location relations used in the present specification such as “upper”, “lower”, “left” and “right” are employed for the convenience of explanation, and in case drawings illustrated in the present specification are inversed, the location relations described in the specification may be inversely understood.

When a component, controller, device, element, unit, apparatus, or the like of the present disclosure is described as having a purpose or performing an operation, function, or the like, the component, controller, device, element, unit, apparatus, or the like should be considered herein as being “configured to” meet that purpose or to perform that operation or function. Each component, controller, device, element, unit, apparatus, and the like may separately embody or be included with a processor and a memory, such as a non-transitory computer readable media, as part of the apparatus.

Hereinafter, embodiments of the present disclosure are described with reference to the accompanying drawings.

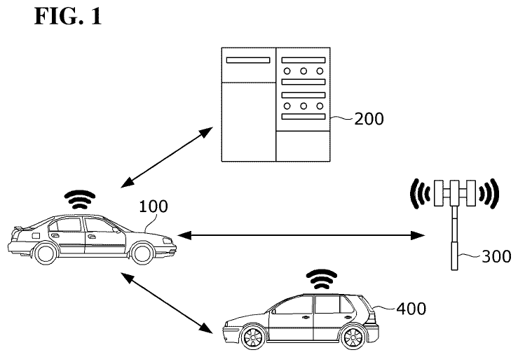

Hereinafter, a vehicle and a server used to acquire learning data for a driving assistance model are described with reference to FIGS. 1-3. In the present disclosure, embodiments are mainly described in which a vehicle 100 acquires sensor data that may be utilized as learning data based on vehicle data from sensor data, for example, image data, acquired by its own sensor, and transmits the sensor data to a server 200 that learns and distributes a driving assistance model with the learning data. However, the above-described embodiment is also applicable to another embodiment in which the server 200 receives the sensor data of the vehicle 100 and the vehicle data, selects sensor data available as learning data based on the vehicle data, and learns the driving assistance model by the selected sensor data.

FIG. 1 is a diagram illustrating that a vehicle communicates with another device to transmit and receive data.

Referring to FIG. 1, the vehicle 100 may be driven based on an electrical energy or fossil energy. In the case of electrical energy, the vehicle 100 may, for example, employ a purely battery-based vehicle driven solely by a high-voltage battery or a gas-based fuel cell as the energy source. Further, the fuel cell may utilize various forms of gas capable of generating electrical energy, and the gas may be filled into the vehicle 100 in a liquefied state, for example. In an embodiment, the gas may be hydrogen, for example. However, various gases are applicable without being limited thereto. In the case of fossil energy, the vehicle 100 may be equipped with an internal combustion engine that is driven based on a fuel, such as gasoline, diesel, or liquefied gas, and that drives an actuating unit 116 by combustion of the fuel. An engine may be included in a power source unit 114 in terms of providing a wheel driving unit 118 with the driving rotational force of the wheel. As another example, the vehicle 100 may selectively utilize the energy of a fossil energy based internal combustion engine and an electric battery to drive the actuating unit 116, which may be a hybrid type of vehicle.

The vehicle 100 may refer to a device that may move. The vehicle 100 may be a ground vehicle driving on the ground, and may be a conventional passenger or commercial vehicle, a purpose built vehicle (PBV), or the like. The vehicle 100 may be a four-wheeled vehicle, such as a passenger car, an SUV, a small truck, or may be a vehicle with more than four wheels, such as a bus, a large truck, a container carrier, a heavy-duty vehicle, or the like. The vehicle 100 may be a robot in its broadest sense, such as a moving means, and the robot may be moved using wheels, tracks, or other moving modules.

The vehicle 100 may be controlled and driven through autonomous driving. The autonomous driving may be implemented as semi-autonomous driving or fully autonomous driving. The fully autonomous driving may be provided as autonomous movement in which the processor 120 of the vehicle 100 takes full control without user intervention, even when the driving situation is uncertain. The semi-autonomous driving may be provided as autonomous movement where driver intervention is required depending on the particular driving situation. The semi-autonomous driving may be implemented such that the processor 120 switches control to the user while deactivating autonomous driving when the above situation occurs, thereby causing the user to perform manual driving. According to the level of autonomous driving defined by the Society of Automotive Engineers SAE International, the semi-autonomous driving may correspond to autonomous driving levels 1 to 4, and the fully autonomous driving may correspond to level 5.

The vehicle 100 may perform communication with another device 200, 300 or another vehicle 400. Other devices may include, for example: a server 200 that supports various controls, state management, and driving of the vehicle 100; an intelligent transportation system (ITS) device 300 for receiving information from the ITS, various types of user devices, and/or the like. The server 200 is, for example, an external device operated by a vehicle manufacturer or provided for servicing autonomous driving. The server 200 may receive connection data of the vehicle 100 or transmit data necessary for autonomous driving. The server 200 may transmit various information and software modules used for control of the vehicle 100 to the vehicle 100 in response to requests and data transmitted from the vehicle 100 and a user device, to support autonomous driving and various services of the vehicle 100.

The ITS device 300 is, for example, a roadside base station (road side unit; RSU), and the ITS device 300 may mutually exchange vehicle recognition data, driving control and state data, environmental data around the vehicle, map data, and the like via V2I with the vehicle 100, to assist the user in driving his/her own vehicle or support autonomous driving of the vehicle 100. The vehicle 100 may interchange the above-listed data via V2V with the other vehicle 400 to support manual driving or autonomous driving.

The vehicle 100 may communicate with other vehicles or other devices based on cellular communication, wireless access in vehicular environment (WAVE) communication, dedicated short range communication (DSRC) or near field communication, or other communication schemes.

For example, the vehicle 100 may use a communication network such as long term evolution (LTE) or 5G, a WiFi communication network, a WAVE communication network, or the like as a cellular communication network for communication with the server 200, the ITS device 300, and the other vehicle 400. As another example, direct short-range communications (DSRC) or the like used in the vehicle 100 may be used for communication between vehicles. A communication manner between the vehicle 100, the server 200, the ITS device 300, the other vehicle 400, and the user device is not limited to the foregoing embodiment.

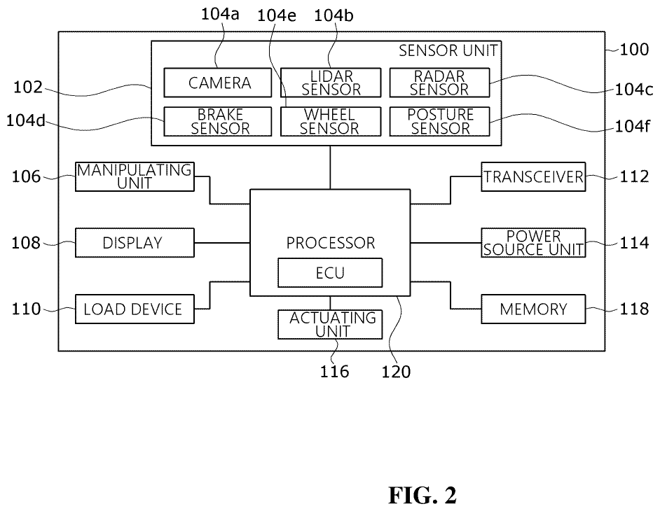

FIG. 2 is a diagram illustrating modules included in or constituting a vehicle, according to an embodiment of the present disclosure.

The vehicle 100 may include a sensor unit 102, a manipulating unit 106, a display 108, a load device 110, and a transceiver 112.

The sensor unit 102 may include various types of sensors or detectors for sensing various conditions and situations occurring in an external environment, an internal system, a user operation, and a boarding space of the vehicle 100.

For example, the sensor unit 102 may include an externally-oriented camera 104a, a lidar sensor 104b, a radar sensor 104c, and the like to recognize dynamic and static objects existing outside the vehicle 100. The camera 104a may generate image data by recognizing an external object as an image during use of the vehicle 100, and may transmit the image data to the processor 120. The lidar sensor 104b may generate point cloud data as the recognized data of the external object and transmit the point cloud data to the processor 120 to generate three-dimensional spatial information identifying at least the shape of the external object. The radar sensor 104c may emit radio waves of a specific frequency around the vehicle 100 to generate radar data via the radio waves reflected from the external object in order to understand the presence and relative distance, velocity, direction, etc. of the external object. Although illustrated in the present disclosure as having the lidar sensor 104b, in other examples the lidar sensor 104a may not be mounted.

The sensor unit 102 may further include a brake sensor 104d, a wheel sensor 104e, and a posture sensor 104f. The brake sensor 104d may output a braking degree or an energy value applied to a brake pedal or the like, and may be, for example, a brake position sensor (BPS). The wheel sensor 104e may detect a wheel speed, a wheel rotation angle of the wheel, a wheel rotation angular velocity, and the like. The posture sensor 104f may detect three-axis states of the vehicle 100, for example, yaw, pitch, and roll, and output various posture states of the vehicle based on the above-described parameters. The posture sensor 104f may include or be configured by, for example, an IMU sensor, a gyro sensor, or the like. In addition, the sensor unit 102 may include a positioning sensor for confirming the new position of the vehicle. The present disclosure mainly describes the sensors of the sensor unit 102 referred to in the description of the embodiment, and may further include sensors that sense various situations not listed therein.

The manipulating unit 106 may be configured as a module for a user to navigate for driving. For example, the manipulating unit 106 may include a steering wheel for manual driving, an automatic or manual transmission actuator, an accelerator pedal, a brake pedal, a gear transmission, or the like. The gear transmission may receive a control instruction related to a driving direction and a stop of the vehicle 100, and provide a user with selection authority for the control instruction divided into, for example, P (stop or park), D (travel forward), R (travel backward), and N (neutral). The manipulating unit 106 may further include an interface for use, release, and selection of detailed functions of the autonomous driving mode requested by the user, so that the user uses the autonomous driving function. The manipulating unit 106 may include or be configured with, for example, a hard-type interface provided at a predetermined position inside the vehicle 100 or a soft-type interface capable of touching the display 108 in order to receive various requests related to autonomous driving.

The display 108 may serve as a user interface. The display 108 may display to output, by the processor 120, an operation state of the vehicle 100, a control state, route/traffic information, remaining energy information, content requested by the driver, and the like. In addition, the display 108 may be configured as a touch screen on which driver input is detectable, so as to receive a request from the driver instructing the processor 120.

The load device 110 is mounted on the vehicle 100, and may be a type of non-driving electric device excluding a driving power system such as the wheel driving unit 118. The load device 114 may be an auxiliary device that receives power from the power source unit 114, and may be, for example, an air conditioning system, a lighting system, a seat system, various devices installed in the vehicle 100, or the like.

The transceiver 112 may support mutual communication with a server 200, a ITS device 300, and surrounding vehicles 400 and the like. The transceiver 112 may include, for example, a module that processes cellular communication, WAVE, DSRC communication, and the like. In an embodiment of the present disclosure, the transceiver 112 may transmit data generated or stored during driving to the server 200, and receive data and a software module transmitted from the server 200. The transceiver 112 may support communication with an electronic device carried by an occupant inside the vehicle 100. In an embodiment of the present disclosure, the vehicle 100 may transmit and receive data utilized in the method according to the present disclosure to and from the outside through the transceiver 112.

The vehicle 100 may also include a power source unit 114 and an actuating unit 116.

The power source unit 114 may generate and supply power and electric power to be used for the driving power system and the non-driving power system, such as the actuating unit 118. The non-driving power system may include, for example, but not limited to, the sensor unit 102, the manipulating unit 106, the display 108, the load device 110, the transceiver 112, and/or the like. The non-driving power system may include various components that implement sensing, interface, communication, and convenience functions except for components directly involved in a driving operation. When the vehicle 100 is driven based on electrical energy, the power source unit 114 may, for example, include or consist of an electrical battery which is charged from the outside, or of a combination of an electrical battery and a fuel cell which charges the battery. In the case of a combination of an electrical battery and a fuel cell, the power source unit 114 may include a tank that stores a material used to produce the power of the fuel cell, such as liquefied hydrogen. When the vehicle 100 is driven based on a fossil energy, the power source unit 114 may be configured as an internal combustion engine. Further, when the vehicle 100 is of a hybrid type, the power source unit 114 may be provided by a combination of an internal combustion engine and an electric battery.

The actuating unit 116 includes at least one module that implements a driving operation. The actuating unit 116 may perform at least one driving operation of longitudinal control such as acceleration and deceleration, lateral control such as steering, and gear shifting according to a user request from the manipulating unit 106 or a request of the processor 120. In an embodiment, the gear shift may be processed by a manual driving user using a gear transmission or by a request of the processor 120 in autonomous driving. The gear shift is a control instruction related to the driving direction and the stop of the vehicle 100, and may be, for example, a control instruction divided into P (stop or park), D (forward driving), R (rear driving), and N (neutral).

The actuating unit 116 may include a wheel driving unit (not shown), a mechanical component and an electronic module for implementing a driving operation on the wheel driving unit, so as to implement a driving operation according to an instruction of the processor 120 by a manual operation of a user or autonomous driving. When the vehicle 100 is operated based on an electrical energy, the actuating unit 116 may include an assembly for communicating the requested driving action to the wheel driving unit 118. When the vehicle 100 is operated based on a fossil energy, the actuating unit 116 may include a transmission and a gear module that transmit power of the internal combustion engine.

The wheel driving unit may include a plurality of wheels, a driving force generation module for generating a driving force and applying or transmitting the driving force to the wheels, a braking module for decelerating driving of the wheels, and a steering module for realizing lateral control of the wheels. When the vehicle 100 is driven based on electric energy, the driving force generation module may be configured as a motor assembly that generates a driving force based on electric power output from an electric battery. The braking module of the electric-based vehicle 100 may further have a regenerative braking function.

In addition, the vehicle 100 may include a memory 118 and a processor 120.

The memory 118 may store an application and various data for control of the vehicle 100, so as to load the application or read and record data at the request of the processor 120. In an embodiment of the present disclosure, the memory 118 may store an application and at least one instruction for acquiring learning data for a driving assistance model. The application may acquire sensor data selected as learning data based on the vehicle data output from the sensor unit 102 and the processor 120 from the image data acquired by the camera 104a, and may transmit the sensor data to the server 200.

In addition, the memory 118 may embed a driving assistance model configured with an artificial intelligence network, so as to implement an autonomous driving function of the vehicle 100. The driving assistance model may be a deep learning-based network that supports or controls road driving and autonomous driving in various specific driving situations. The specific driving situation may be a situation according to autonomous parking driving. The driving assistance model for implementing autonomous parking may include a surrounding environment prediction model utilized in autonomous parking driving. The surrounding environment prediction model may be a model that identifies a surrounding object of the vehicle 100 by means of sensor data acquired from the vehicle 100, for example, image data, and predicts a behavior of the vehicle 100 due to the surrounding object. In order to improve the autonomous driving function, the vehicle 100 may receive update information of the model distributed from the server 200, for example, update information about a learnable parameter of the model, and may update the driving assistance model managed in the memory 118 by using the update information.

The processor 120 may perform overall control of the vehicle 100. The processor 120 may be configured to execute applications and instructions stored in the memory 118. The processor 120 may generate, according to a driving control request in manual driving and autonomous driving, a control instruction for a component of the vehicle 100. The component may be at least one of the various components described in FIG. 2. For example, the processor 120 may generate gear shift data including a driving direction and a control instruction related to stopping and transmit the gear shift data to the actuating unit 116 so that the actuating units 116 control autonomous driving according to various driving situations.

The processor 120 may execute a process of acquiring vehicle data including at least one of a state of a component of the vehicle 100 occurring in driving and a control instruction for the component and image data for detecting the surrounding environment by the camera 104a. The state of the component is the state data of the component of the vehicle 100 detected from the sensor unit 102, and the component may include at least one of the members of the vehicle 100 described in FIG. 2, as described above. The processor 120 may perform processing to generate behavior information of the vehicle 100 based on motion of the vehicle 100 estimated from the vehicle data. The processor 120 may implement a process of acquiring the image data of the vehicle 100 related to the behavior information matching the target behavior as the learning data of the driving assistance model. The processor 120 may transmit the learning data to the server 200. The processor 120 may receive the driving assistance model trained or updated based on the learning data by the server 200. The processor 120 may control the vehicle 100 using the driving assistance model. For example, the processor 120 may control the autonomous driving of the vehicle 100 using the driving assistance model. In an example, the processor 120 may control the actuator unit 116 and/or other vehicle components using the driving assistance. Details related to the above-described processing, according to an embodiment, is provided below.

The processor 120 is illustrated in FIG. 2 in the configuration of a single processing module configured to perform the processing described above. In an embodiment, the processor 120 may include an ECU that performs at least a part of the above-described processing. In another example, the processor 120 may include a plurality of processing modules, and the processing may be distributed and processed by the plurality of modules.

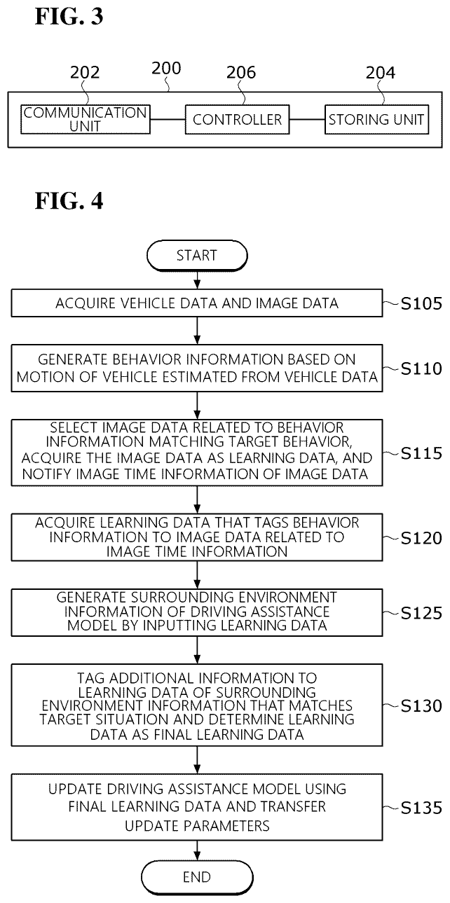

FIG. 3 is a diagram illustrating modules included in or constituting a server, according to another embodiment of the present disclosure.

The electronic device executing the use of interest request using latency prediction according to embodiments of the present disclosure may be illustrated as a server 200 in communication with the vehicle 100.

The server 200 may learn or update the driving assistance model based on learning data including at least image data received from the vehicle 100, and may transmit the model or update information of the model to the vehicle 100.

The server 200 may include a communication unit 202, a storing unit 204, and a controller 206.

The communication unit 202 may transmit and receives data to and from an external device, may support mutual communication with the vehicle 100 according to embodiments of the present disclosure, and may exchange data with the vehicle 100.

The storing unit 204 may store an application for operating the server 200 and various data, and may load the application or read and record data at the request of the controller 206. In an embodiment of the present disclosure, the storing unit 204 may manage the travel assistance model built in the vehicle 100. When the driving assistance model is an artificial intelligence network, the storing unit 204 may retain parameters of the model and store update information due to re-learning of the model.

The controller 206 may perform overall control of the server 200. The server 200 may be configured to execute applications and instructions stored in the storage 204. The controller 206 may execute the application to process and respond to the user's request sent from the vehicle 100. In connection with embodiments of the present disclosure, the controller 206 may, for example, analyze learning data including at least image data received from the vehicle 100 to tag the learning data matching the target situation with the additional information related to the target situation, and determine the tagged learning data as final learning data. The controller 206 may use the final learning data to learn or update the driving assistance model and transmit the model or update information of the model to the vehicle 100. As another example, the controller 206 may receive the image data and the vehicle data from the vehicle 100 to generate the behavior information of the vehicle 100, may select the image data associated with the behavior information matching the target behavior, and may select it as the learning data.

The controller 206 is illustrated in the present disclosure as consisting of a single processing module. In another example, the controller 206 may be distributed to a plurality of processing modules, and the above processing may be executed by a distributed processing model.

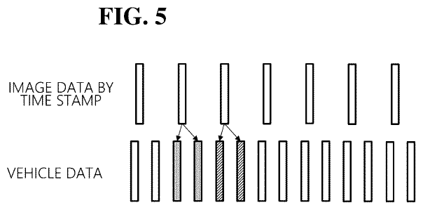

Hereinafter, the acquisition processing of the learning data and the learning/updating processing of the driving assistance model performed in the vehicle 100 and the server 200, according to embodiments, are described in more detail with reference to FIGS. 4-10. The following embodiments are mainly described as an example in which the vehicle 100 acquires the learning data and transmits the learning data to the server 200. In addition, the driving situation in the following embodiments is parking, autonomous driving is also illustrated as autonomous parking driving, and the driving assistance model may include at least a surrounding environment prediction model utilized in autonomous parking driving. However, the present disclosure is not limited thereto, and is also applicable to autonomous driving according to various driving situations. In addition, the processor 120 and the controller 206 that perform the method according to embodiments of the present disclosure may be described interchangeably with the vehicle 100 and the server 200 for convenience of description.

FIG. 4 is a flowchart of a method for acquiring learning data, according to an embodiment of the present disclosure.

In an operation S105, the processor 120 of the vehicle 100 may acquire vehicle data including at least one of a state of a component of the vehicle 100 occurring in driving and a control instruction for the component and image data for detecting the surrounding environment by the camera 104a.

The component may be the actuating unit 116, the manipulating unit 106, the processor 120 that generates control instructions to actuate the actuating units 116, and/or the power source unit 114 described in FIG. 2. The vehicle data may include detailed vehicle data related to the state of the component. The detailed vehicle data associated with the state may include longitudinal state data and lateral state data of the actuating unit 116 occurring during driving. In the present disclosure, the longitudinal state data and the lateral state data may be referred to as longitudinal data and lateral data, respectively, and may be extracted from RAW control area network (CAN) data. The longitudinal data may have, for example, the speed (WHL_SpdFLVal) of a particular wheel (front left wheel), the braking degree or energy value (IEB_EstTtBrkFrcNmVal) applied to the brake, etc. The example longitudinal data described above may be detected by the wheel sensor 104e, the brake sensor 104d, etc. The lateral data may have, for example, a Yaw Rate value (IMU_YawRtVal) of the vehicle body, a steering wheel rotation angle (SAS_AnglVal), a steering wheel angular speed of rotation (SAS_SpdFRVal), etc. The lateral data in the above example may be detected by the wheel sensor 104e, the posture sensor 104f, or the like.

The vehicle data may further include detailed vehicle data related to control instructions for the components, and may be extracted from RAW control area network (CAN) data. The control instruction may be provided by the processor 120. For example, the processor 120 may generate gear shift data including a driving direction and a control instruction related to stopping and transmit the gear shift data to the actuating unit 116 so that the actuating units 116 control autonomous driving according to a driving situation. The gear shift data may be, for example, control commands which are divided into P (stop or park), D (forward travel), R (rear travel) and N (neutral). Accordingly, the gear shift state (VCU_GearPosStaDisp) according to the gear shift data may be recognized in the processor 120.

In an embodiment, the vehicle data may be acquired, for example, as illustrated in FIG. 5. FIG. 5 is a diagram illustrating acquisition of vehicle data. The processor 120 may acquire detailed vehicle data determined by searching using image time information of image data acquired at a predetermined period. The image data may be acquired periodically, but the vehicle data may be detected upon the occurrence of an action or event associated with the detailed vehicle data. In view of the above, the processor 120 may select vehicle data recently encountered with the time stamp by adopting the time stamp of the video data of the specific viewpoint as a reference, as illustrated in FIG. 5. The selection of the recently encountered vehicle data may use, for example, binary search logic. The processor 120 may acquire vehicle data according to image data of all frames, or may acquire vehicle data corresponding to image data of frames selected at discrete intervals. Accordingly, the vehicle data may be grouped according to image time information of each image data and matched with each image data. Although the above-described example is described with the selection of the recently encountered vehicle data by the binary search logic, the present disclosure is not limited thereto. For example, the vehicle data within a predetermined section may be selected from the time stamp of the image data.

The vehicle data may be acquired in a different manner than in FIG. 5, for example by acquiring detailed vehicle data without associating the data with image data. Considering that all kinds of detailed vehicle data do not always occur or are caused by desynchronization, the processor 120 of the vehicle 100 may acquire, together with the gear shift data, at least one of the longitudinal data and the lateral data determined by a search using shift time information of the gear shift data. For example, the processor 120 may adopt the time stamp of the gear shift data as a reference, and may select the longitudinal data and/or the lateral data encountered with the time stamp. The processor 120 may acquire, by the above manner, the longitudinal data and the lateral data each time the shift state in the gear shift data changes. Accordingly, the longitudinal data and/or the lateral data may be matched to the respective gear shift data for the respective shift time information and grouped with the gear shift data. The selection manner of vehicle data according to another example may also be used in an embodiment in which the behavior information is generated by the server 200 that receives the vehicle data and the image data.

Referring back to FIG. 4, in an operation S110, the processor 120 of the vehicle 100 may generate behavior information of the vehicle 100 based on the motion of the vehicle estimated from the vehicle data.

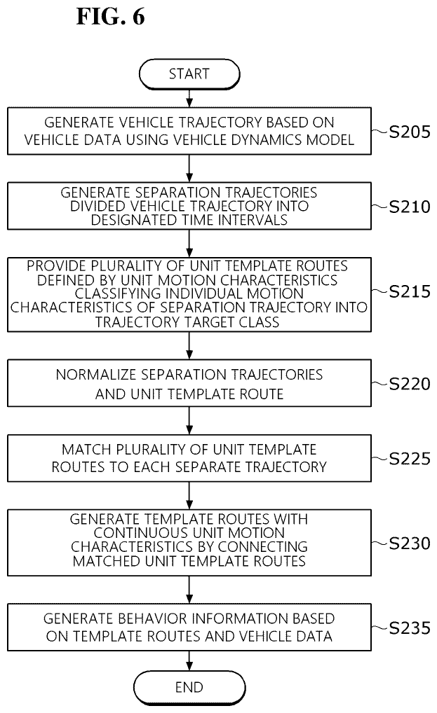

The operation S110, according to an embodiment, is described in more detail with reference to FIG. 6. FIG. 6 is a flowchart of a process of generating behavior information, according to an embodiment.

In an operation S205, the processor 120 of the vehicle 100 may generate, by using the vehicle dynamics model, the trajectory of the vehicle 100 based on the vehicle data matched according to specific time information.

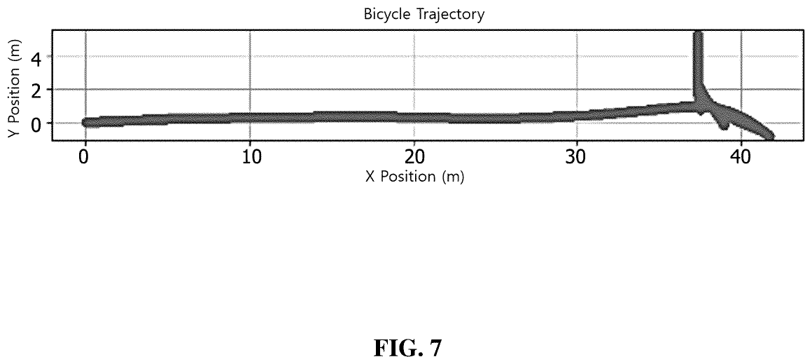

The specific time information may be, for example, a time stamp according to the image time information or the shift time information described in connection with the operation S105. The vehicle data may include at least one of longitudinal data, lateral data, and gear shift data, as described in connection with the operation S105. When the driving situation is parking, the vehicle dynamics model may use a model suitable for low speed, e.g. a bicycle model, to model the route during parking in the low speed state. The processor 120 may analyze the vehicle data mutually matched by the bicycle model to form an overall trajectory of the vehicle 100 in a parking situation in a two-dimensional route form, as illustrated in FIG. 7. FIG. 7 is a diagram illustrating a trajectory of a vehicle generated by a vehicle dynamics model, according to an embodiment.

By means of the bicycle model, the lateral motion of the vehicle 100 may be modeled well.

In an operation S210, the processor 120 may generate a separation trajectory by dividing the trajectory of the vehicle 100 into designated time intervals.

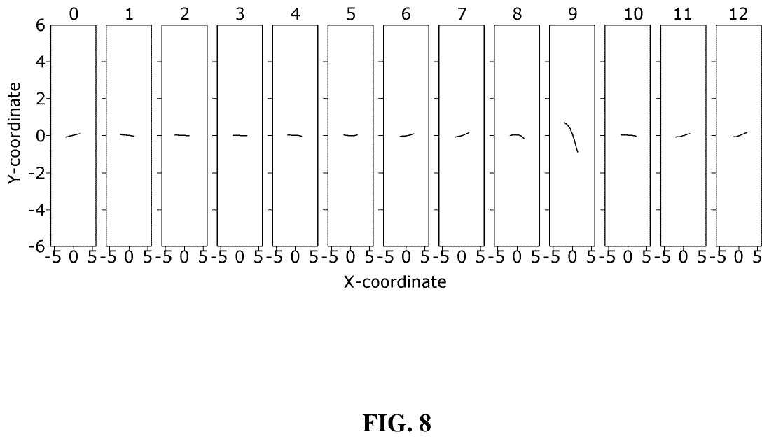

When the vehicle data is matched based on the image time information, the specified time period may be, for example, a window size defined by the number of frames of the image data. The number of frames may be 70. When the vehicle data is matched based on the shift time information, the specified time period may be a time window size set by the processor 120. The entire trajectory may be divided into window-sized sections, and a plurality of divided trajectories corresponding to the number of sections may be generated, as illustrated in FIG. 8. FIG. 8 is a diagram illustrating a separation trajectory, according to an embodiment.

In an operation S215, the processor 120 may provide a plurality of unit template routes defined by unit motion characteristics classified the individual motion characteristics of the separation trajectory into the trajectory target class (S215).

The individual motion characteristic of the separation trajectory may be a simplified motion of the separation trajectory that is inferred by analyzing the separation trajectory, by the processor 120. Simplified motion may relate to forward straight, backward straight, left turn, right turn, stop, etc. The processor 120 may identify representative individual motion characteristics that appear in the separation trajectory to define a trajectory target class. The trajectory target classes may be classified as go-forward, go-backward, turn-right, turn-left, stop, etc., reflecting representative individual motion characteristics according to the examples above. The classification of the trajectory target class corresponds to a unit motion characteristic, and the unit motion characteristic may indicate a movement state of the vehicle 100 defined in any one of the trajectory target classes. The movement state may be described to include presence or absence of movement, a straight-ahead direction, and a turning direction.

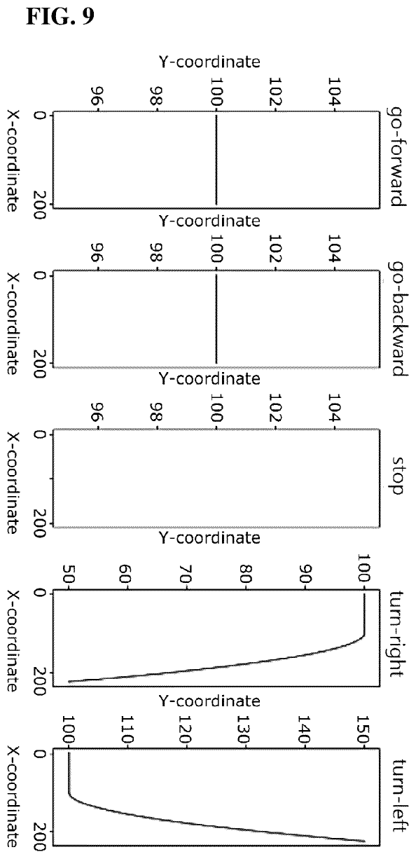

The processor 120 may then generate a unit template route defined by the unit motion characteristics classified by trajectory target class, as illustrated in FIG. 9. That is, the unit template route may be generated to have a unit motion characteristic indicative of a particular movement state of the vehicle 100. FIG. 9 is a diagram illustrating a unit template route, according to an embodiment. The unit template route having each unit motion characteristic may be provided for each of go-forward, go-backward, turn-right, turn-left, and stop, as illustrated in FIG. 9.

Although the present disclosure describes that the unit template route is generated based on the separation trajectory, the unit template route may be provided independently of the separation trajectory in other examples. Specifically, in the present disclosure, the trajectory target classes are described as being classified by identifying representative individual motion characteristics of the separation trajectories, but the unit motion characteristics are already provided based on the predefined trajectory target classes, and a pre-provisioned unit template route for each unit motion characteristic may be generated or provided in advance.

In an operation S220, the processor 120 may normalize the separation trajectory and the unit template route.

Each separation trajectory is generated for each specified time period, and distances of routes in each separation trajectory may be different from each other. In particular, the movement distance of the vehicle 100 along the lateral direction Y of the separation trajectory has a small deviation from the movement distance in the lateral direction X in the unit template route, but the movement distance of vehicle 100 along the longitudinal direction X of the separation trajectory may have a large deviation from the movement length in the longitudinal direction X in the units template route, as compared to the lateral direction. In view of this, the processor 120 may normalize the separation trajectory associated with the movement distance in the longitudinal direction X and the unit template route corresponding thereto.

In an operation S225, the processor 120 may respectively match the plurality of normalized unit template routes for each normalized separation trajectory.

Since the unit template route and the separation trajectory represent time-series two-dimensional routes, the matching may be performed in a non-linear matching manner, rather than a manner based on a typical distance per corresponding coordinate between the route and the trajectory. For example, the non-linear matching manner may use non-linear matching using dynamic time warping between the unit template route and the separation trajectory. Accordingly, a unit template route most similar to each separation trajectory may be determined.

In an operation S230, the processor 120 may connect the matched unit template routes to generate template routes with continuous unit motion characteristics.

The processor 120 may list the unit motion characteristics of each unit template route, and arrange each unit motion characteristic in a continuous form. For example, when each of the unit template routes matching the separation trajectory has a unit motion characteristic, such as go-forward, go-forward. stop, go-backward, turn-right, etc., the successive unit motion characteristics may be listed to have a sequential arrangement of the characteristics of the examples described above.

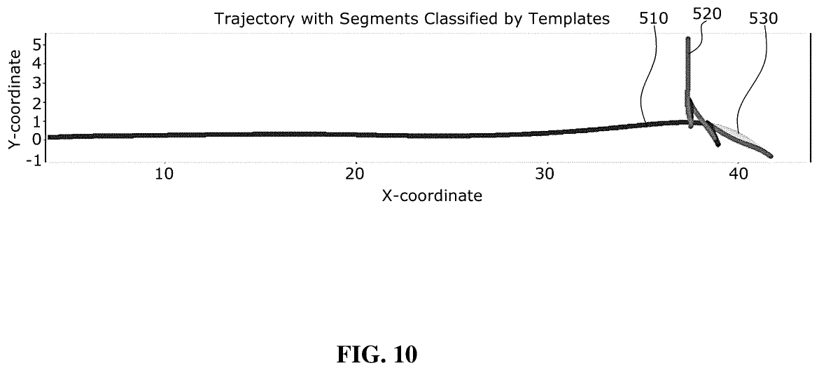

The template route may be output to have unit motion characteristics that are continuous along the trajectory, as illustrated in FIG. 10. FIG. 10 is a diagram illustrating a template route, according to an embodiment. FIG. 10 shows a template route having unit motion characteristics in units of segments. The segment unit may be designated to include at least one unit template route. The segment unit is a unit applied to generate the behavior information in an operation S235, which is described in more detail below. Referring to FIG. 10, it is shown that the unit motion characteristic in units of segments on the left side is go-forward 510, the unit motion characteristic of units of segments in the center is turn-left 520, and the unit motion characteristic is go-backward 530.

In the operation S235, the processor 120 may generate behavior information based on the template route and the vehicle data.

The behavior information may include behavior attribute data generated by analyzing unit motion characteristics represented by templated motion of the vehicle 100 according to a trajectory caused by driving of the vehicle 100 and vehicle data corresponding thereto. The vehicle data may include at least one of longitudinal data, lateral data, and gear shift data used to generate the separation trajectory matching the unit motion characteristic. The behavioral attribute data may be data describing an operating situation of the vehicle 100 For example, the behavioral attribute data may be generated to describe abstract operating states and unit motion characteristics for the vehicle 100 behaving in a particular driving situation. The unit motion characteristic of the behavioral attribute data may be, for example, a right-turn, a left-turn, or the like, and when the driving situation is parking, the abstract operation state of the behavior attribute data may be parking space search, parking or pull-out, or the like. The plurality of behavioral attribute data may be arranged in time series.

The behavior information may further include, for another example, vehicle data corresponding to the behavior attribute data, together with the behavior attribute data. Here, the behavior generation data may be arranged in time series and managed in association with the vehicle data used for generation of the behavior attribute data.

Hereinafter, details related to the operation S235, according to an embodiment, are described.

The processor 120 may search for a unit template route corresponding to a shift time at which the gear shift data is generated among a plurality of unit template routes constituting the template route. The processor 120 may identify a unit template route belonging to the first time from the searched unit template route. The first time is, for example, a time corresponding to a predetermined number of frames of image data, and may be a time corresponding to 100 frames. Then, from the identified unit template route to the template unit template route of the second time or more, in a case where there is no gear shift data, the processor 120 may separate a plurality of unit template routes belonging to the second time into template routes in units of segments. The second time is, for example, a time corresponding to a predetermined number of frames of image data, and may be a time corresponding to 300 frames. When the second time is set to be greater than the first time, the first and second times are not limited to the example described above. On the other hand, when there is the gear shift data for the second time, the processor 120 may separate the unit template routes before and after the gear shift data into two segment units.

The segment units described in connection with the operation S230 are substantially the same as those described above. Since the segment unit includes at least one unit template route, for ease of description, the segment unit may be referred to as a series of unit template routes or may be interchangeably described in the present disclosure unless there is a technical contradiction.

In the driving situation of parking, when the unit template route (or the template route in units of segments) corresponding to the gear shift data is the stop and the gear shift data are the stop instruction (the gear shift P), the processor 120 may generate the behavior information to have the behavior attribute data that determines the abstract operation state as parking.

In a driving situation of parking, when the gear shift data is an indication of a driving direction (gear shift D, R) and the lateral data and the longitudinal data of a specific wheel satisfy all of the threshold conditions, the processor 120 may generate the behavior information to have behavior attribute data that determines an abstract operation state as parking or pull-out. The lateral data is, for example, the steering wheel rotation angle (SAS_AnglVal), and the threshold condition of the lateral data may be that SAS_AngleVal is greater than or equal to 400. The longitudinal data of the particular wheel is, for example, the speed of the front left wheel (WHL_SpdFLVal), and the threshold condition of the longitudinal data may be that WHL_SplFLVal is less than or equal to a predetermined threshold (e.g., is less than or equal to 6).

In a driving situation of parking, when the gear shift data is an indication of a driving direction (gear shift D, R), and at least one of the lateral direction data and the longitudinal direction data does not satisfy the above-described threshold condition, the processor 120 may generate the behavior information to have the behavior attribute data based on the unit motion characteristic.

In the driving situation of parking, when there is no gear shift data in the unit template route subsequent to the unit template route searched corresponding to the shift time of the gear shift data, the processor 120 may generate the behavior information so as to have the behavior attribute data that determines the abstract operation state as the parking space search. Here, the unit template route may be described as being replaced with a template route of a segment unit.

Referring back to FIG. 4, in an operation S115, the processor 120 of the vehicle 100 may select image data related to the behavior information matching the target behavior, acquire the image data as the learning data, and notify the server 200 of the image time information of the image data selected as the learning data.

The target behavior may be a behavior event of the vehicle 100 required in the learning of the driving assistance model. In addition, the behavior event is a behavior characteristic of the vehicle 100 that is abnormal in the driving situation assumed by the driving assistance model, and may be a behavior characteristic that needs to be analyzed in the driving assistance model. When the driving situation is parking, the abnormal behavior characteristic may be, for example, a sudden stop during parking or exiting, a sudden turn, a sudden acceleration, or the like.

The processor 120 may analyze the behavior attribute data and the vehicle data that constitute the behavior information to select the behavior information corresponding to the target behavior. In an embodiment, the vehicle data may be at least one of longitudinal data and lateral data. For example, the longitudinal data may be a braking degree or an applied energy value of the brake, a wheel speed, or the like, and the lateral data may be a rotation angle of the steering wheel, a rotation angular velocity thereof, a Yaw rate of the vehicle 100, or the like. Taking the selection of the behavior information as an example, the processor 120 may analyze the braking degree of the brake, the wheel speed, the rotation angle/rotation angular velocity of the steering wheel, and the like related to the behavior attribute data indicated by parking or unparking in the template route in units of segments. As a result of the analysis, when the behavior information in the template route of the specific segment unit is estimated to be the target behavior, for example, a sudden stop during parking or unparking, it may be determined that the corresponding behavior route of the processor 120 conforms to the target behavior.

The processor 120 may check a time stamp of the determined behavior information on the template route, and determine and store image time information corresponding to the time stamp and image data thereof. The image data thus determined may be utilized as learning data.

In addition, the processor 120 may transmit the image time information to the server 200 while the vehicle 100 is driving, and the server 200 may store the image time information in the storing unit 204.

In an operation S120, the processor 120 of the vehicle 100 transmits the learning data in which the behavior information is tagged in the video data associated with the video time information to the server 200, whereby the server 200 may acquire the learning data.

The vehicle 100 may receive the image time information from the server 200 according to a periodic request of the server 200 or a transmission condition of the vehicle 100. The transmission condition of the vehicle 100 may be a condition that the vehicle 100 transmits the image data designated as the learning data to the server 200. The transmission condition is set based on a specific state of the vehicle 100 and may be, for example, a start-off of the vehicle 100, a pause or transmission period of the vehicle 100 or the like. As another example, the vehicle 100 may immediately transmit the image data acquired as the learning data to the server 200 in the operation S115. In this case, the operation S120 may be omitted.

The processor 120 of the vehicle 100 may identify the image data corresponding to the received image time information and transmit the learning data processed to tag the identified image data with its behavior information to the server 200. In another example, the processor 120 may transmit the image data without tagging of the behavior information to the server 200 as learning data. In addition to the autonomous driving data generated during driving of the vehicle 100, when the learning data is transmitted to the server 200, a burden on processing and transmission of the processor 120 is caused, but according to step S120, the burden on the processing and transmission may be reduced.

In an operation S125, the controller 206 of the server 200 may generate the surrounding environment information of the driving assistance model by input of the learning data.

When the driving assistance model is, for example, a surrounding environment prediction model, the surrounding environment prediction model may receive, as an input, image data in which behavior information is tagged, identify a surrounding object of the vehicle 100 and a driving situation of the vehicle 100, and may generate surrounding environment information indicating a behavior of the vehicle 100 due to the identified object. When the driving situation is parking, the surrounding situation information may be, for example, a sudden stop due to pedestrian identification during parking, a sudden stop caused by another vehicle during exiting, or the like.

In an operation S130, the controller 206 of the server 200 may tag the learning data of the surrounding environment information matching the target situation with the additional information, and determine the tagged learning data as final learning data.

When the target situation is a sudden stop or the like due to a sudden appearance of a pedestrian or another vehicle while parking, the controller 206 may select the surrounding environment information that is the same as or similar to the illustrated target situation, and utilize the image data of the selected surrounding environment information as the final learning data. The additional information that is tagged may have at least one of behavior information, surrounding environment information, and image time information.

In an operation S135, the controller 206 of the server 200 may learn or update the driving assistance model using the final learning data, and deliver the driving assistance model or update information thereof to the vehicle 100. The update information may be an update parameter of the driving assistance model generated by re-learning the driving assistance model.

Although the description of FIG. 4 is an embodiment in which the vehicle 100 acquires the learning data and transmits the learning data to the server 200, in an embodiment in which the server 200 selects or acquires the learning data based on the image data and the vehicle data transmitted by the vehicle 100, the entire process of FIG. 4 may be substantially performed in the server 200.

According to embodiments of the present disclosure, it is possible to provide a method and a device for acquiring learning data that achieve an improvement in acquisition efficiency and a reduction in acquisition time for high-quality learning data.

In addition, according to embodiments of the present disclosure, when the vehicle route prediction network and the surrounding environment prediction network in the parking situation are learned using the learning data in which the image data set is tagged, network learning may be performed for various parking classes.

In addition, according to embodiments of the present disclosure, by selecting learning data matching the target situation and re-learning the network, the improved driving assistance model may be distributed to the vehicle in real time.

Effects that may be obtained in the present disclosure are not limited to the above-mentioned effects. Other effects that are not mentioned herein should be more clearly understood by those having ordinary skill in the art in the art to which the present disclosure pertains from the following description.

While the example methods according to embodiments of the present disclosure described above are represented as a series of operations for clarity of description, it is not intended to limit the order in which the steps or operations are performed, and the steps or operations may be performed simultaneously or in different order as necessary. In order to implement the method according to the present disclosure, the described steps may further include other steps or operations, may include remaining steps or operations instead of some of described the steps or operations, or may include other additional steps or operations in addition to some of the described steps or operations.

The described embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the present disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

What is claimed is:

1. A method for acquiring learning data for a driving assistance model, the method comprising:
acquiring vehicle data including at least one of a state of a component of a vehicle occurring in driving or a control instruction for the component and image data for detecting an surrounding environment by a sensor of the vehicle;
generating behavior information of the vehicle based on motion of the vehicle estimated from the vehicle data;
acquiring image data of the vehicle related to the behavior information matching a target behavior as learning data;
learning a driving assistance model using the learning data; and
controlling the vehicle using the driving assistance model.

2. The method of claim 1, wherein the vehicle data includes at least one of longitudinal data of the vehicle, lateral data of the vehicle, or gear shift data indicating a driving direction and a stop of the vehicle.

3. The method of claim 2, wherein the vehicle data is acquired from at least one of i) the gear shift data and at least one of longitudinal data or lateral data determined by search using shift time information of the gear shift data or ii) the vehicle data determined by searching using image time information of the image data.

4. The method of claim 1, wherein the behavior information includes the vehicle data and behavior attribute data generated by analyzing the vehicle data and a unit motion characteristic represented by templated motion of the vehicle according to a trajectory caused by driving of the vehicle, and wherein the behavior attribute data is arranged in a plurality in time series and is managed in association with the vehicle data used for generation of the behavior attribute data.

5. The method of claim 1, wherein generating the behavior information includes:
generating a trajectory of the vehicle based on the vehicle data;
dividing the trajectory into specified time periods to generate a separation trajectory;
respectively matching a plurality of unit template routes defined by unit motion characteristics classified according to individual motion characteristics of the separation trajectory into trajectory target classes for each separation trajectory;
connecting the matched unit template routes to generate template routes with continuous unit motion characteristics; and
generating the behavior information based on the template routes and the vehicle data.

6. The method of claim 5, further comprising defining the trajectory target classes based on the individual motion characteristics of the separation trajectory, before matching the plurality of unit template routes, to provide a unit template route for each of the defined trajectory target classes.

7. The method of claim 5, wherein matching the plurality of unit template routes includes matching the plurality of unit template routes using non-linear matching based on dynamic time warping between the unit template route and the separation trajectory.

8. The method of claim 5, further comprising normalizing a separation trajectory and a unit template route before matching the plurality of unit template routes.

9. The method of claim 5, wherein:
the vehicle data includes longitudinal data of the vehicle, lateral data of the vehicle, and gear shift data indicating a direction of driving and a stop of the vehicle; and
the generating behavior information includes
searching, among the plurality of unit template routes constituting the template routes, a unit template route corresponding to a shift time at which the gear shift data is generated,
generating the behavior information, so as to have behavior attribute data that is determined to be parking, based on determining that the unit template route corresponding to the gear shift data include a stop and the gear shift data include a stop instruction,
generating the behavior information, so as to have behavior attribute data that is determined to be parking or exiting, based on determining i) that the gear shift data includes an indication of a driving direction and ii) that the lateral data and the longitudinal data of a specific wheel satisfy threshold conditions,
generating the behavior information so as to have behavior attribute data based on a unit motion characteristic, based on determining i) that the gear shift data includes an indication of the driving direction and ii) that at least one of the lateral direction data or the longitudinal direction data does not satisfy a threshold condition, and
generating the behavior information so as to have behavior attribute data determined by parking space searching, based on determining that there is no gear shift data in the unit template route subsequent to the unit template route searched corresponding to the shift time.

10. The method of claim 1, wherein:
acquiring image data includes i) selecting, by the vehicle, image data related to the behavior information matching the target behavior, to acquire the image data as the learning data and ii) notifying, by the vehicle, image time information of the image data selected as the learning data to a server;
and the method further comprises, before the learning the driving assistance model,
transmitting, by the server, the image time information to the vehicle in response to satisfaction of a transmission condition in the vehicle, and
transmitting, by the vehicle, learning data in which the behavior information is tagged to the image data associated with the image time information to the server.

11. The method of claim 1, wherein learning the driving assistance model includes:
generating surrounding environment information of the driving assistance model by input of the learning data;
determining learning data of the surrounding environment information corresponding to a target situation as final learning data; and
training or updating the driving assistance model using the final learning data.

12. The method of claim 1, wherein the driving includes an autonomous parking operation of the vehicle, and wherein the driving assistance model comprises an artificial intelligence network and includes a surrounding environment prediction model utilized in the autonomous parking operation.

13. A device for acquiring learning data for a driving assistance model, the device comprising:
a transceiver for transmitting and receiving data with an external device;
a memory configured to store at least one computer-readable instruction; and
a processor configured to execute the at least one computer-readable instruction stored in the memory,
wherein the processor is configured to
acquire vehicle data including at least one of a state of a component of a vehicle occurring in driving and a control instruction for the component and image data for detecting a surrounding environment by a sensor of the vehicle,
generate behavior information of the vehicle based on motion of the vehicle estimated from the vehicle data,
acquire image data of the vehicle related to the behavior information matching a target behavior as learning data of the driving assistance model, and
control the vehicle using the driving assistance model learned with the learning data.

14. The device of claim 13, wherein the vehicle data includes at least one of longitudinal data of the vehicle, lateral data of the vehicle, or gear shift data indicating a driving direction and a stop of the vehicle.

15. The device of claim 14, wherein the vehicle data is acquired from at least one of i) the gear shift data and at least one of longitudinal data or lateral data determined by a search using shift time information of the gear shift data or ii) the vehicle data determined by a searching using image time information of the image data.

16. The device of claim 13, wherein the behavior information includes the vehicle data and behavior attribute data generated by analyzing the vehicle data and a unit motion characteristic represented by templated motion of the vehicle according to a trajectory caused by driving of the vehicle, wherein the behavior attribute data is arranged in a plurality in time series and is managed in association with the vehicle data used for generation of the behavior attribute data.

17. The device of claim 13, wherein the processor is configured to:
generate a trajectory of the vehicle based on the vehicle data;
divide the trajectory into specified time periods to generate a separation trajectory;
respectively match a plurality of unit template routes defined by unit motion characteristics classified individual motion characteristics of the separation trajectory into trajectory target classes for each separation trajectory;
connect the matched unit template routes to generate template routes with continuous unit motion characteristics; and
generate the behavior information based on the template route and the vehicle data.

18. The device of claim 17, wherein the processor is further configured to, before matching the plurality of unit template routes according to the separation trajectories, define the trajectory target classes based on the individual motion characteristics of the separation trajectory, to provide a unit template route for each of the defined trajectory target classes.

19. The device of claim 17, wherein:
the vehicle data comprises longitudinal data of the vehicle, lateral data of the vehicle and gear shift data indicating a direction of driving and a stop of the vehicle; and
the processor is configured to
search, among the plurality of unit template routes constituting the template routes, a unit template route corresponding to a shift time at which the gear shift data is generated,
generate the behavior information, so as to have behavior attribute data that is determined to be parking, when the unit template route corresponding to the gear shift data includes a stop and the gear shift data are a stop instruction,
generate the behavior information so as to have behavior attribute data that is determined to be parking or exiting, based on determining i) that the gear shift data includes an indication of a driving direction ii) that lateral data and longitudinal data of a specific wheel satisfies threshold conditions, and
generate the behavior information so as to have behavior attribute data based on the unit motion characteristics, based on determining i) that the gear shift data includes an indication of the driving direction and ii) that at least one of the lateral direction data or the longitudinal direction data does not satisfy a threshold condition; and
generate the behavior information so as to have behavior attribute data determined by parking space searching, based on determining that there is no gear shift data in the unit template route subsequent to the unit template route searched corresponding to the shift time.

20. The device of claim 13, wherein the processor is configured to:
select image data related to the behavior information matching the target behavior, to acquire the image data as the learning data;
notify image time information of the image data selected as the learning data to the external device; and
transmit learning data in which the behavior information is tagged to the image data associated with the image time information received from a server in response to fulfillment of transmission conditions to the external device.
